(19) United States
(12) Patent Application Publication
(10) Pub. No.: US 2019/0015988 A1
(43) Pub. Date: Jan. 17, 2019

(54) ROBOT CONTROL DEVICE, ROBOT, ROBOT SYSTEM, AND CALIBRATION METHOD OF CAMERA FOR ROBOT

(71) Applicant: Seiko Epson Corporation, Tokyo (JP)

(72) Inventors: Mitsuhiro INAZUMI, Shiojiri (JP); Takahiko NODA, Azumino (JP)

(21) Appl. No.: 16/030,959

(22) Filed: Jul. 10, 2018

(30) Foreign Application Priority Data
Jul. 11, 2017 (JP) 2017-135108

(51) Int. Cl. B25J 9/16

(52) U.S. Cl. CPC B25J 9/1692; B25J 9/1697

(57) ABSTRACT

An processor moves an arm to rotate a calibration pattern around three rotation axes linearly independent from each other and to stop at a plurality of rotation positions. A processor causes a camera to capture a pattern image of the calibration pattern at the plurality of rotation positions. A processor estimates parameters of the camera for calculating a coordinate transformation between a target coordinate system and a camera coordinate system using a pattern image captured at the plurality of rotation positions.

### BACKGROUND

### 1. Technical Field

The present invention relates to calibration of a camera for a robot.

### 2. Related Art

There are cases where a camera is installed in a robot to have a function of an eye in order to make the robot perform advanced processing. As an installation method of the camera, there are a method of installing the camera independently of a robot arm and a method of installing the camera on a hand (hand eye) so as to be interlocked with the movement of the robot arm.

In JP-A-2010-139329, a system that performs calibration related to a camera installed independently of a robot arm is disclosed. An object of this system is to stably and accurately detect a featured portion of a calibration tool without depending on illumination condition and to make the system easy to handle with low cost.

According to the technique described in JP-A-2010-139329, it is necessary to grasp a relative positional relationship between the featured portion of the calibration tool and a calibration target beforehand with high accuracy. For example, in a case of acquiring extrinsic parameters of a camera, it is necessary to dispose the featured portion such that a relative position and a relative attitude between the featured portion of the calibration tool and a supporting tool on which the camera is mounted to be a specified value. However, it is not always easy to set the relative positional relationship between the featured portion of the calibration tool and the calibration target beforehand with high accuracy. Therefore, there is a demand for a technique that can easily perform camera calibration by a method different from the technique described in JP-A-2010-139329.

### SUMMARY

An advantage of some aspects of the invention is to solve at least a part of the problems described above, and the invention can be implemented as the following aspects.

(1) According to a first aspect of the invention, a control device is provided. The control device controls a robot having an arm provided with a calibration pattern of a camera and the camera provided independently of the arm. The control device includes an arm control unit that controls the arm; a camera control unit that controls the camera; and a camera calibration execution unit that determines parameters of the camera for calculating a coordinate transformation between a target coordinate system having a known relative position and attitude with respect to a robot coordinate system of the robot and a camera coordinate system of the camera. The arm control unit moves the arm to rotate each calibration pattern around each of three rotation axes linearly independent from each other and to stop at a plurality of rotation positions. The camera control unit causes the camera to capture a pattern image of the calibration pattern at the plurality of rotation positions. The camera calibration execution unit determines the parameters using the pattern image captured at the plurality of rotation positions.

In the control device, it is possible to estimate directions of the three rotation axes seen in the camera coordinate system using the pattern image of the plurality of rotation positions in the rotation around each rotation axis. Since the three rotation axes are linearly independent of each other, it is possible to determine a coordinate transformation matrix between the target coordinate system and the camera coordinate system from the directions of these rotation axes. As a result, the parameters of the camera for calculating the coordinate transformation between the target coordinate system and the camera coordinate system can be acquired, and thereby it is possible to detect the position of the target using the camera.

(2) In the control device, the three rotation axes may be set around an origin point of the target coordinate system.

According to the control device with this configuration, since correspondence relation between the three rotation axes and the target coordinate system is simple, it is possible to easily determine the coordinate transformation matrix between the target coordinate system and the camera coordinate system from the directions of the rotation axes seen in the camera coordinate system.

(3) In the control device, the camera calibration execution unit may estimate three rotation vectors having a direction of each rotation axis as a vector direction and an angle of the rotation as a vector length from the pattern image captured at the plurality of rotation positions, may normalize each of the three rotation vectors to acquire three normalized rotation vectors, and may determine a rotation matrix constituting a coordinate transformation matrix between the target coordinate system and the camera coordinate system by arranging the three normalized rotation vectors as a row component or a column component.

According to the control device with this configuration, it is possible to easily acquire the rotation matrix constituting the coordinate transformation matrix between the target coordinate system and the camera coordinate system from the pattern image captured at the plurality of rotation positions in the rotation around each of the rotation axes.

(4) In the control device, the coordinate transformation matrix between the target coordinate system and the camera coordinate system may be represented by a product of a first transformation matrix between the camera coordinate system and a pattern coordinate system of the calibration pattern and a second transformation matrix between the pattern coordinate system and the target coordinate system. In this case, the camera calibration execution unit may (a) estimate the first transformation matrix from the pattern image captured at one specific rotation position among the plurality of the rotation positions, (b) estimate a square sum of two translation vector components in two coordinate axis directions orthogonal to each rotation axis among three components of a translation vector constituting the second transformation matrix from the pattern image captured at the plurality of rotation positions, and calculate the translation vector constituting the second transformation matrix from the square sum of the translation vector components estimated respectively for the three rotation axes, and (c) calculate a translation vector constituting the coordinate transformation matrix from the first transformation matrix estimated at the specific rotation position and the translation vector of the second transformation matrix.

According to the control device with this configuration, it is possible to easily acquire the translation vector constituting the coordinate transformation matrix between the target coordinate system and the camera coordinate system from the pattern image captured at the plurality of rotation positions in the rotation around each of the rotation axes.

(5) In the control device, the target coordinate system may be a coordinate system having a relative position and attitude fixed with respect to the robot coordinate system of the robot independently of the arm.

According to the control device with this configuration, since the coordinate transformation matrix between the target coordinate system and the camera coordinate system set independently of the arm is acquired, it is possible to improve accuracy of position detection of the target using the camera at a position away from the arm.

(6) In the control device, the target coordinate system may be a hand coordinate system of the arm.

According to the control device with this configuration, at the hand position of the arm, it is possible to improve the accuracy of position detection of the target using the camera.

(7) According to a second aspect of the invention, a control device is provided. The control device controls a robot having an arm provided with a calibration pattern of a camera and the camera provided independently of the arm. The control device includes a processor. The processor moves the arm to rotate each calibration pattern around each of three rotation axes linearly independent from each other and to stop at a plurality of rotation positions; causes the camera to capture a pattern image of the calibration pattern at the plurality of rotation positions; and determines parameters of the camera for calculating a coordinate transformation between a target coordinate system having a known relative position and attitude with respect to a robot coordinate system of the robot and a camera coordinate system of the camera using the pattern image captured at the plurality of rotation positions.

According to the control device, it is possible to estimate directions of the three rotation axes seen in the camera coordinate system using the pattern image of the plurality of rotation positions in the rotation around each rotation axis. Since the three rotation axes are linearly independent of each other, it is possible to determine a coordinate transformation matrix between the target coordinate system and the camera coordinate system from the direction of these rotation axes. As a result, the parameters of the camera for calculating the coordinate transformation between the target coordinate system and the camera coordinate system can be acquired, and thereby it is possible to detect a position of the target using the camera.

(8) According to a third aspect of the invention, a robot connected to the control device described above is provided.

According to the robot, it is possible to perform coordinate transformation between the target coordinate system and the camera coordinate system and detect a position of the target using the camera.

(9) According to a fourth aspect of the invention, a robot system including a robot and the control device described above connected to the robot is provided.

According to the robot system, it is possible to perform coordinate transformation between the target coordinate system and the camera coordinate system and detect a position of the target using the camera.

(10) According to a fifth aspect of the invention, a method for performing camera calibration in a robot system including a robot having an arm provided with a calibration pattern of a camera and the camera provided independently of the arm is provided. The method includes moving the arm to rotate each calibration pattern around each of three rotation axes linearly independent from each other and to stop at a plurality of rotation positions; causing the camera to capture a pattern image of the calibration pattern at the plurality of rotation positions; and determining parameters of the camera for calculating a coordinate transformation between a target coordinate system having a known relative position and attitude with respect to a robot coordinate system of the robot and a camera coordinate system of the camera using the pattern image captured at the plurality of rotation positions.

According to the method, it is possible to estimate directions of the three rotation axes seen in the camera coordinate system using the pattern image at the plurality of rotation positions around each rotation axis. Since the three rotation axes are linearly independent of each other, it is possible to determine a coordinate transformation matrix between the target coordinate system and the camera coordinate system from the direction of these rotation axes. As a result, the parameters of the camera for calculating the coordinate transformation between the target coordinate system and the camera coordinate system can be acquired, and thereby it is possible to detect a position of the target using the camera.

The invention can be realized in various forms other than the above. For example, the invention can be realized in forms of a computer program for realizing a function of a control device, a non-transitory storage medium on which the computer program is recorded, and the like.

### BRIEF DESCRIPTION OF THE DRAWINGS

The invention will be described with reference to the accompanying drawings, wherein like numbers reference like elements.

FIG. 1 is a schematic diagram of a robot system.

FIG. 2 is a block diagram illustrating functions of a robot and a control device.

FIG. 3 is an explanatory diagram illustrating a robot coordinate system.

FIG. 4 is a flowchart illustrating a processing procedure of an embodiment.

FIG. 5 is an explanatory diagram illustrating an example of pattern images at a plurality of rotation positions.

FIG. 6 is a table showing an example of a rotation matrix acquired in step S160 of FIG. 4.

FIG. 7 is a graph in which a translation vector is projected on a YZ plane of a camera coordinate system.

FIG. 8 is a table showing an example of a translation vector acquired in step S170 of FIG. 4.

FIG. 9 is an explanatory diagram illustrating a robot coordinate system in a second embodiment.

### DESCRIPTION OF EXEMPLARY EMBODIMENTS

### A. Configuration of Robot System

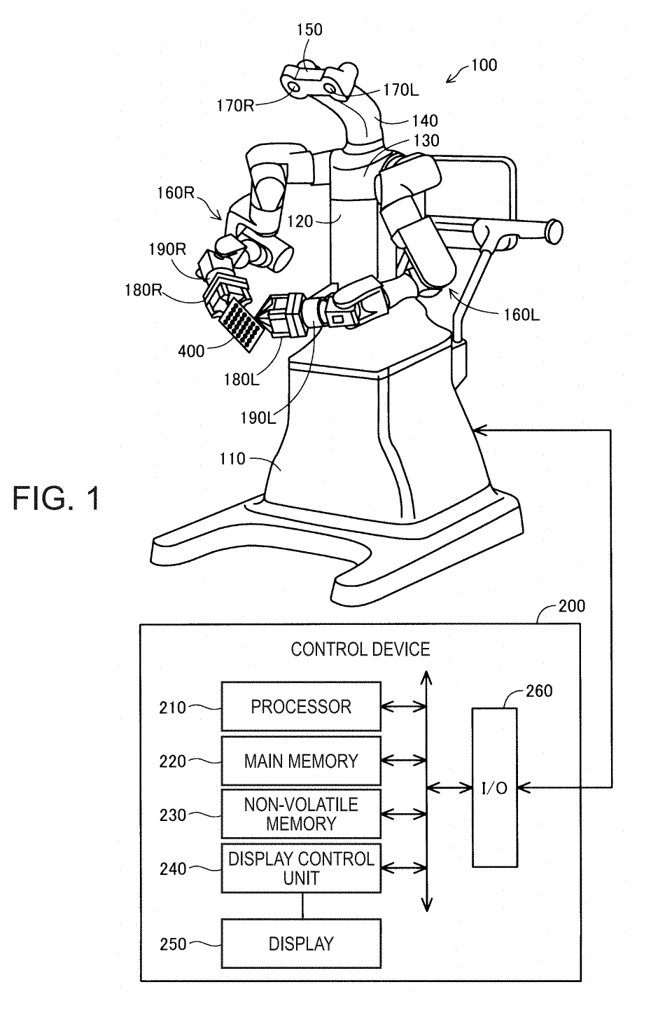

FIG. 1 is a schematic diagram of a robot system in an embodiment. The robot system is provided with a robot 100 and a control device 200. The robot 100 is an autonomous robot capable of performing work while recognizing a work target with a camera, freely adjusting force, and autonomously determining. The robot 100 can operate as a teaching playback robot for performing a work according to prepared teaching data.

The robot 100 is provided with a base 110, a body portion 120, a shoulder portion 130, a neck portion 140, a head portion 150, and two arms 160L and 160R. Hands 180L and 180R are detachably attached to the arms 160L and 160R. These hands 180L and 180R are end effectors for holding a workpiece or a tool. Cameras 170L and 170R are installed in the head portion 150. These cameras 170L and 170R are provided independently of the arms 160L and 160R, and are fixed cameras whose position and attitude are not changed. A calibration pattern 400 for the cameras 170L and 170R can be installed in the arms 160L and 160R.

Force sensors 190L and 190R are provided in a wrist portion of the arms 160L and 160R. The force sensors 190L and 190R are sensors for detecting a reaction force or a moment with respect to a force that the hands 180L and 180R exert on the workpiece. As the force sensors 190L and 190R, for example, it is possible to use a six-axis force sensor capable of simultaneously detecting six components of force components in translational three-axis directions and the moment components around three rotation axes. The force sensors 190L and 190R are optional.

The letters “L” and “R” appended to the end of symbols of the arms 160L and 160R, the cameras 170L and 170R, the hands 180L and 180R, and the force sensors 190L and 190R mean “left” and “right”. In a case where these distinctions are unnecessary, explanations will be made using symbols without the letters “L” and “R”.

The control device 200 includes a processor 210, a main memory 220, a non-volatile memory 230, a display control unit 240, a display 250, and an I/O interface 260. These units are connected via a bus. The processor 210 is, for example, a microprocessor or a processor circuit. The control device 200 is connected to the robot 100 via the I/O interface 260. The control device 200 may be stored in the robot 100.

As a configuration of the control device 200, various configurations other than the configuration illustrated in FIG. 1 can be adopted. For example, the processor 210 and the main memory 220 can be deleted from the control device 200 of FIG. 1, and the processor 210 and the main memory 220 may be provided in another device communicably connected to the control device 200. In this case, the entire device including the another device and the control device 200 functions as a control device of the robot 100. In another embodiment, the control device 200 may have two or more of the processors 210. In still another embodiment, the control device 200 may be realized by a plurality of devices communicably connected to each other. In these various embodiments, the control device 200 is configured as a device or a device group including one or more of the processors 210.

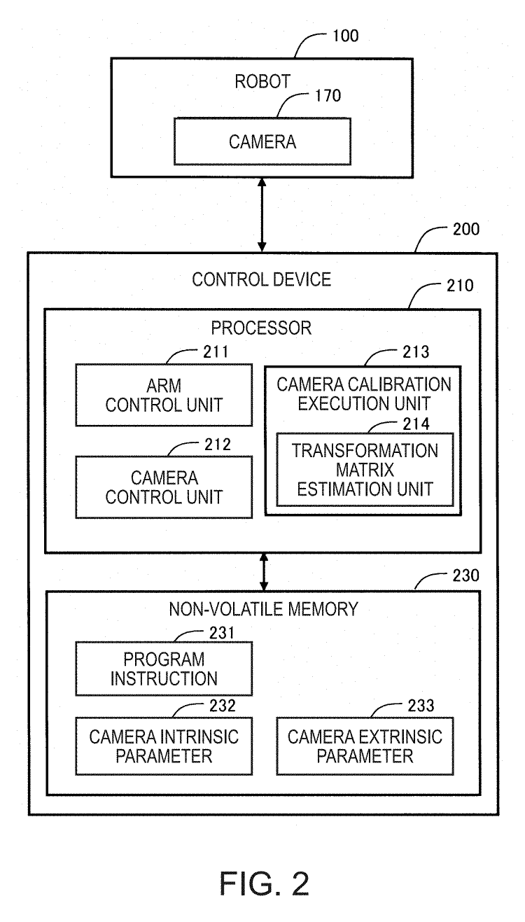

FIG. 2 is a block diagram illustrating functions of the robot 100 and the control device 200. The processor 210 of the control device 200 realizes each function of an arm control unit 211, a camera control unit 212, and a camera calibration execution unit 213 by executing various program instructions 231 previously stored in the non-volatile memory 230. The camera calibration execution unit 213 includes a transformation matrix estimation unit 214. A part or all of the functions of these units 211 to 214 may be realized by a hardware circuit. The functions of these units 211 to 214 will be described later. A camera intrinsic parameter 232 and a camera extrinsic parameter 233 are stored in the non-volatile memory 230 in addition to the program instructions 231. These parameters 232 and 233 will be described later.

### B. Robot Coordinate System and Coordinate Transformation

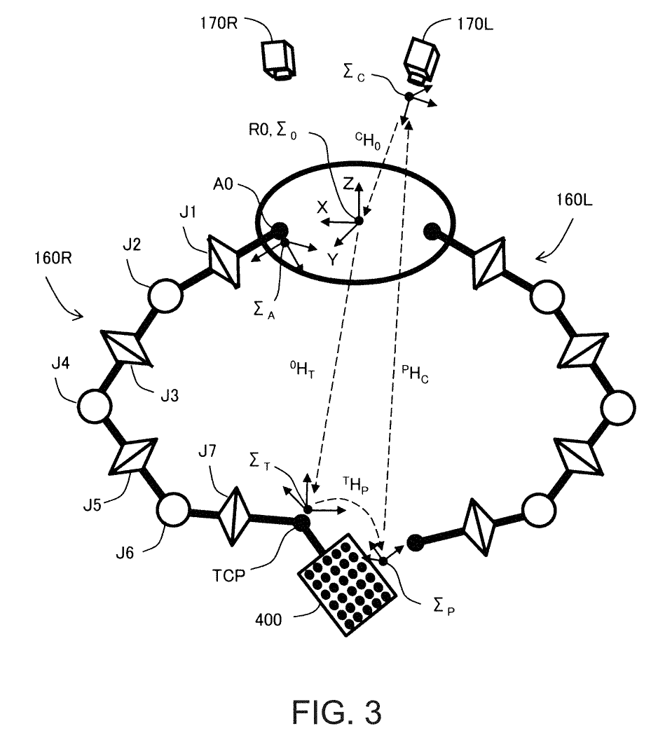

FIG. 3 is an explanatory diagram illustrating a configuration of an arm 160 of the robot 100 and various coordinate systems. Each of the two arms 160L and 160R is provided with seven joints J1 to J7. Joints J1, J3, J5, and J7 are twisting joints and joints J2, J4, and J6 are bending joints. A twisting joint is provided between the shoulder portion 130 and the body portion 120 in FIG. 1, but is not shown in FIG. 3. The individual joints are provided with an actuator for moving the joints and a position detector for detecting a rotation angle.

A tool center point (TCP) is set on at an end of the arm 160. Typically, control of the robot 100 is executed to control a position and attitude of the tool center point TCP. A position and attitude means three coordinate values in a three-dimensional coordinate system and a state defined by rotation around each coordinate axis. In the example in FIG. 3, the calibration pattern 400 used in calibration of a camera 170 is fixed on the end of the right arm 160R. When attaching the calibration pattern 400 to the arm 160R, the hand 180R may be removed.

The calibration of the camera 170 is a process for determining an intrinsic parameter and an extrinsic parameter of the camera 170. The intrinsic parameter is a specific parameter of the camera 170 and the lens system thereof, and includes, for example, a projective transformation parameter, a distortion parameter, and the like. The extrinsic parameter is a parameter used when calculating a relative position and attitude between the camera 170 and the arm 160 of the robot 100, and includes a parameter for expressing translation or rotation between a robot coordinate system Σ₀ and a camera coordinate system Σ_{C}. However, the extrinsic parameter can be configured as a parameter for expressing translation or rotation between the camera coordinate system Σ_{C} and a target coordinate system other than the robot coordinate system Σ₀. The target coordinate system may be a coordinate system acquired from the robot coordinate system Σ₀. For example, a coordinate system having a known relative position and attitude fixed with respect to the robot coordinate system Σ₀, and a coordinate system in which the relative position and attitude with respect to the robot coordinate system Σ₀ according to movement amount of a joint of the arm 160 may be selected as a target coordinate system. The extrinsic parameter corresponds to “a camera parameter for calculating the coordinate transformation between the target coordinate system and a camera coordinate system of the camera”.

In FIG. 3, the following coordinate system is drawn as a coordinate system related to the robot 100.

(1) Robot coordinate system Σ₀: a coordinate system having a reference point R0 of the robot 100 as a coordinate origin point

(2) Arm coordinate system Σ_{A}: a coordinate system having a reference point A0 of the arm 160 as a coordinate origin point

(3) Hand coordinate system Σ_{T}: a coordinate system having a tool center point (TCP) as a coordinate origin point

(4) Pattern coordinate system Σ_{P}: a coordinate system having a predetermined position on the calibration pattern 400 as a coordinate origin point

(5) Camera coordinate system Σ_{C}: a coordinate system set in the camera 170

The arm coordinate system Σ_{A} and the hand coordinate system Σ_{T} are individually set in the right arm 160R and the left arm 160L. In the example in FIG. 3, since the calibration pattern 400 is fixed to the end of the right arm 160R, the arm coordinate system Σ_{A} of the right arm 160R and the hand coordinate system Σ_{T} are used in the following description. The relative position and attitude between the arm coordinate system Σ_{A} and the robot coordinate system Σ₀ is already known. The camera coordinate system Σ_{C} is also individually set on the right eye camera 170R and the left eye camera 170L. In the following explanation, a coordinate system of the left eye camera 170L is mainly used as the camera coordinate system Σ_{C}, but a coordinate system of the right eye camera 170R may also be used as the camera coordinate system Σ_{C}. In FIG. 3, for convenience of the drawings, the origin points of individual coordinate system are drown at a position shifted from the actual potion.

In general, a transformation from a certain coordinate system Σ_{A} to another coordinate system Σ_{B}, or transformation of position and attitude in these coordinate systems can be expressed as a homogeneous transformation matrix ^{A}H_{B} illustrated below.

$$\begin{matrix}{}_{}^{A}{H}{}_{B}^{} = ( \begin{matrix}R & T \\ 0 & 1\end{matrix} ) = ( \begin{matrix}{R}_{xx} & {R}_{yx} & {R}_{zx} & {T}_{x} \\ {R}_{xy} & {R}_{yy} & {R}_{zy} & {T}_{y} \\ {R}_{xz} & {R}_{yz} & {R}_{zz} & {T}_{z} \\ 0 & 0 & 0 & 1\end{matrix} ) & ( 1 a ) \\ {R}_{x} = ( \begin{matrix}{R}_{xx} \\ {R}_{xy} \\ {R}_{xz}\end{matrix} ) & ( 1 b ) \\ {R}_{y} = ( \begin{matrix}{R}_{yx} \\ {R}_{yy} \\ {R}_{yz}\end{matrix} ) & ( 1 c ) \\ {R}_{z} = ( \begin{matrix}{R}_{zx} \\ {R}_{zy} \\ {R}_{zz}\end{matrix} ) & ( 1 d )\end{matrix}$$

Here, R represents a rotation matrix, T represents a translation vector, and Rₓ, R_{y}, and R_{z} represent column components of a rotation matrix R. Hereinafter, the homogeneous transformation matrix ^{A}H_{B} is also referred to as “coordinate transformation matrix ^{A}H_{B}”, “transformation matrix ^{A}H_{B}”, or simply “transformation ^{A}H_{B}”. The superscript “^{A}” on the left side of a transformation symbol “^{A}H_{B}” indicates the coordinate system before the transformation, and the subscript “_{B}” on the right side of the transformation symbol “^{A}H_{B}” indicates the coordinate system after the transformation. The transformation ^{A}H_{B} can be also considered as indicating an origin position and basic vector components of the coordinate system Σ_{B} seen in the coordinate system Σ_{A}.

An inverse matrix ^{A}H_{B}⁻¹(=^{B}H_{A}) of the transformation ^{A}H_{B} is given by the following expression.

$${}_{}^{A}{H}{}_{B}^{- 1} = ( \begin{matrix}{R}^{T} & - {R}^{T} \cdot T \\ 0 & 1\end{matrix} ) \qquad ( 2 )$$

The rotation matrix R has the following important properties.

### Rotation Matrix R Property 1

The rotation matrix R is an orthonormal matrix, and an inverse matrix R⁻¹ thereof is equal to a transposed matrix R^{T}.

### Rotation Matrix R Property 2

The three column components Rₓ, R_{y}, and R_{z} of the rotation matrix R are equal to three basic vector components of the coordinate system Σ_{B} after rotation seen in the original coordinate system Σ_{A}.

In a case where the transformations ^{A}H_{B} and ^{B}H_{C} are sequentially applied to a certain coordinate system Σ_{A}, a combined transformation ^{A}H_{C} is acquired by multiplying each of the transformations ^{A}H_{B} and ^{B}H_{C} sequentially to the right.

^{A}H_{C}=^{A}H_{B}·^{B}H_{C} (3)

Regarding the rotation matrix R, the same relationship as Expression (3) is established.

^{A}R_{C}=^{A}R_{B}·^{B}R_{C} (4)

### C. AX=XB Problem of Coordinate Transformation

In FIG. 3, the following transformation is established between a plurality of coordinate systems Σ₀, Σ_{T}, Σ_{P}, and Σ_{C}.

(1) Transformation ⁰H_{T} (calculable): a transformation from the robot coordinate system Σ₀ to the hand coordinate system Σ_{T}

(2) Transformation ^{T}H_{P} (unknown): a transformation from the hand coordinate system Σ_{T} to the pattern coordinate system Σ_{P}

(3) Transformation ^{P}H_{C} (estimable): a transformation from the pattern coordinate system Σ_{P} to the camera coordinate system Σ_{C}

(4) Transformation ^{C}H₀ (unknown): a transformation from the camera coordinate system Σ_{C} to the robot coordinate system Σ₀

The parameter that associates the robot coordinate system Σ₀ and the camera coordinate system Σ_{C} is the transformation ^{C}H₀. Normally, acquiring the transformation ^{C}H₀ corresponds to the calibration of the camera 170.

The calibration of the camera 170 in a first embodiment, TCP is set as a calibration target point, and the hand coordinate system Σ_{T} is selected as the target coordinate system of a calibration target point. Then, a transformation

^{T}H_{C}(=^{T}H_{P}·^{P}H_{C}) or ^{C}H_{T}(=^{C}H_{P}·^{P}H_{T}) between the hand coordinate system Σ_{T} and the camera coordinate system Σ_{C} is estimated. Since the transformation ^{T}H₀ (or ^{C}H_{T}) between the hand coordinate system Σ_{T} and the robot coordinate system Σ₀ is calculable, if the transformation ^{T}H_{C} (or ^{C}H_{T}) between the hand coordinate system Σ_{T} and the camera coordinate system Σ_{C} can be acquired, the transformation ^{C}H₀ (or ⁰H_{C}) between the robot coordinate system Σ₀ and the camera coordinate system Σ_{C} is also calculable. A coordinate system other than the hand coordinate system Σ_{T} can be selected as the target coordinate system, and any coordinate system having the known relative position and attitude with respect to the robot coordinate system Σ₀ can be selected. The case of selecting a coordinate system other than the hand coordinate system Σ_{T} as the target coordinate system will be explained in a second embodiment.

Among the four transformations ⁰H_{T}, ^{T}H_{P}, ^{P}H_{C}, and ^{C}H₀ described above, the transformation ⁰H_{T} is the transformation that connects the robot coordinate system Σ₀ with the hand coordinate system Σ_{T} of the TCP as the calibration target point. Normally, the process of acquiring the position and attitude of the TCP with respect to the robot coordinate system Σ₀ is referred to as a forward kinematics, and is calculable if the geometric shape of the arm 160 and movement amount (rotation angle) of each joint are determined. In other words, the transformation ⁰H_{T} is a calculable transformation. The transformation ⁰H_{A} from the robot coordinate system Σ₀ to the arm coordinate system Σ_{A} is fixed and known.

The transformation ^{T}H_{P} is a transformation from the hand coordinate system Σ_{T} to the pattern coordinate system Σ_{P} of the calibration pattern 400. In JP-A-2010-139329, the transformation ^{T}H_{P} is required to be a known fixed transformation, but it is assumed to be unknown in the present embodiment.

The transformation ^{P}H_{C} is a transformation from the pattern coordinate system Σ_{P} to the camera coordinate system Σ_{C}, an image of the calibration pattern 400 is captured by the camera 170, and can be estimated by performing image processing on the image. The process of estimating the transformation ^{P}H_{C} can be executed using standard software (for example, camera calibration function of OpenCV or MATLAB) for performing camera calibration.

Following the above-described transformations ⁰H_{T}, ^{T}H_{P}, ^{P}H_{C}, and ^{C}H₀ in order will lead to the initial robot coordinate system Σ₀, and the following expression will be established using an identity transformation I.

⁰H_{T}·^{T}H_{P}·^{P}H_{C}·^{C}H₀=I (5)

The following expression can be acquired by multiplying inverse matrixes ⁰H_{T}⁻¹, ^{T}H_{P}⁻¹, and ^{P}H_{C}⁻¹ of each transformation in order from the left on both sides of Expression (5).

^{C}H₀=^{P}H_{C}⁻¹·^{T}H_{P}⁻¹·⁰H_{T}⁻¹ (6)

In Expression (6), the transformation ^{P}H_{C} can be estimated using a camera calibration function, and the transformation ⁰H_{T} is calculable. Accordingly, if the transformation ^{T}H_{P} is known, the right side of the expression is calculable, and the answer of the transformation ^{C}H₀ can be known. This is the reason why the transformation ^{T}H_{P} is assumed to be known in the related art.

On the other hand, if the transformation ^{T}H_{P} is unknown, the right side of Expression (6) is not calculable, and another processing is required. For example, with consideration of two attitudes i and j of the arm 160R in FIG. 3, above-described Expression (5) is established for each of the attitudes, and the following expressions are acquired.

⁰H_{T}(i)·^{T}H_{P}·^{P}H_{C}(i)·^{C}H₀=I (7a)

⁰H_{T}(j)·^{T}H_{P}·^{P}H_{C}(j)·^{C}H₀=I (7b)

By multiplying an inverse matrix ^{C}H₀⁻¹ of the transformation ^{C}H₀ on both Expressions (7a) and (7b) from the right side, following expressions are acquired.

⁰H_{T}(i)·^{T}H_{P}·^{P}H_{C}(i)=^{C}H₀⁻¹ (8a)

⁰H_{T}(j)·^{T}H_{P}·^{P}H_{C}(j)=^{C}H₀⁻¹ (8b)

Although the right sides of Expressions (8a) and (8b) are unknown, since the expressions are the same transformation, the following expression is established.

⁰H_{T}(i)·^{T}H_{P}·^{P}H_{C}(i)=⁰H_{T}(j)·^{T}H_{P}·^{P}H_{C}(j) (9)

When multiplying ⁰H_{T}(J)⁻¹ on the left side and ^{P}H_{C(i)}⁻¹ on the right side on both sides of Expression (9), the following expression is acquired.

(⁰H_{T}(j)⁻¹·⁰H_{T}(i))·^{T}H_{P}=^{T}H_{P}·(^{P}H_{C}(j)·^{P}H_{C}(i)⁻¹) (10)

Here, when the products of the transformation in parentheses of the left and the right sides of Expression (10) are written as A and B, and the unknown transformation ^{T}H_{P} as X, following equation can be acquired.

AX=XB (11)

This is a well-known process as AX=XB problem, and a nonlinear optimization process is required to solve the unknown matrix X. However, there is a problem that there is no guarantee that the nonlinear optimization process will converge to an optimal solution.

As will be described in detail below, in the first embodiment, by causing the calibration pattern 400 to change the predetermined position and attitude using the fact that the arm 160 provided with the calibration pattern 400 can be optionally controlled, it is possible to estimate the transformation ^{T}H_{C}(=^{T}H_{P}·^{P}H_{C}) or ^{C}H_{T}(=^{C}H_{P}·^{P}H_{T}) between the hand coordinate system Σ_{T} which is the target coordinate system and the camera coordinate system Σ_{C}. As a result, it is possible to determine the extrinsic parameter of the camera 170.

### D. Processing Procedure of Embodiment

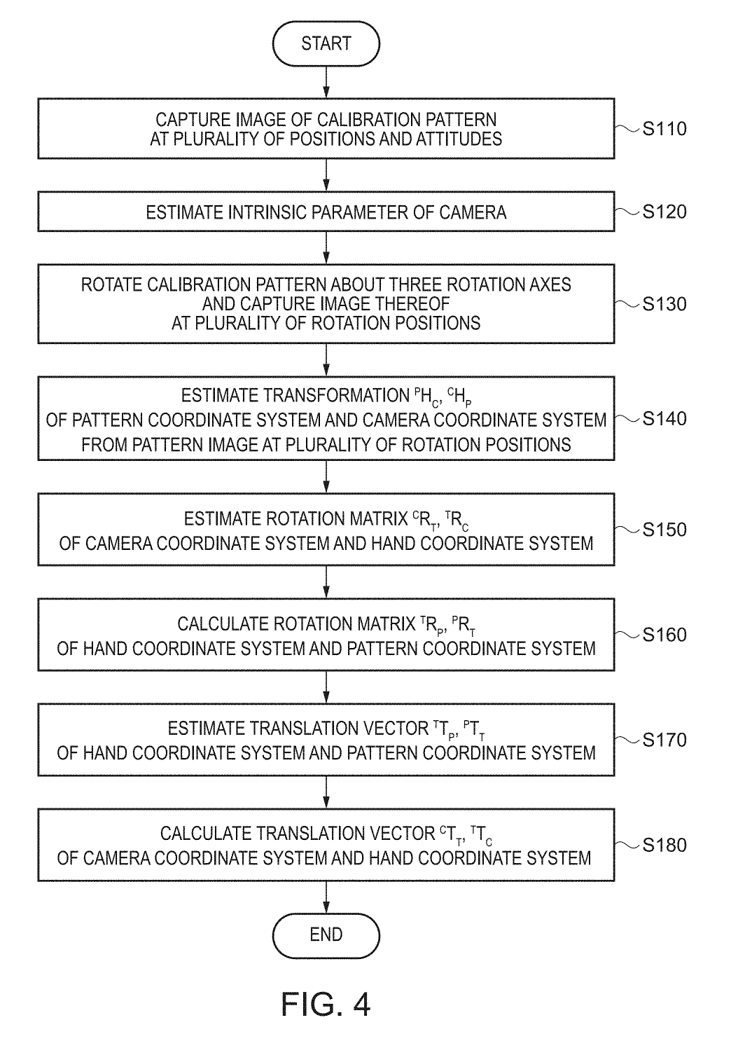

FIG. 4 is a flowchart illustrating a processing procedure of calibration of the camera 170 in an embodiment. The calibration of two cameras 170R and 170L included in the robot 100 is separately performed, but the cameras will be referred to as “camera 170” without particular distinction below. The calibration processing described below is executed with cooperation of the arm control unit 211, the camera control unit 212, and the camera calibration execution unit 213 illustrated in FIG. 2. In other words, the operation of changing the calibration pattern 400 to a plurality of positions and attitudes is executed by the arm 160 being controlled by the arm control unit 211. Capturing an image with the camera 170 is controlled by the camera control unit 212. The intrinsic parameter or extrinsic parameter of the camera 170 is determined by the camera calibration execution unit 213. In the decision of the extrinsic parameter of the camera 170, estimation of various matrixes and vectors are executed by the transformation matrix estimation unit 214.

Step S110 to step S120 are processes for determining the intrinsic parameter of the camera 170. First, in step S110, the camera 170 is used to capture images of the calibration pattern 400 in a plurality of positions and attitudes. Since these plurality of positions and attitudes are to determine the intrinsic parameter of the camera 170, any position and attitude can be applied. In step S120, the camera calibration execution unit 213 estimates the intrinsic parameter of the camera 170 using a plurality of pattern images acquired in step S110. As described above, the intrinsic parameter of the camera 170 is a specific parameter of the camera 170 and the lens system thereof, and includes, for example, a projective transformation parameter, a distortion parameter, and the like. Estimation of the intrinsic parameter can be executed using standard software (for example, camera calibration function of OpenCV or MATLAB) for performing camera calibration.

Steps S130 to S180 are processes for determining the extrinsic parameter of the camera 170. In step S130, the calibration pattern 400 is rotated around three rotation axes of the hand coordinate system Σ_{T}, and an image of the calibration pattern 400 is captured at a plurality of rotation positions in the rotation around each rotation axis. Hereinafter, the captured image of the calibration pattern 400 with the camera 170 is referred to as “pattern image”.

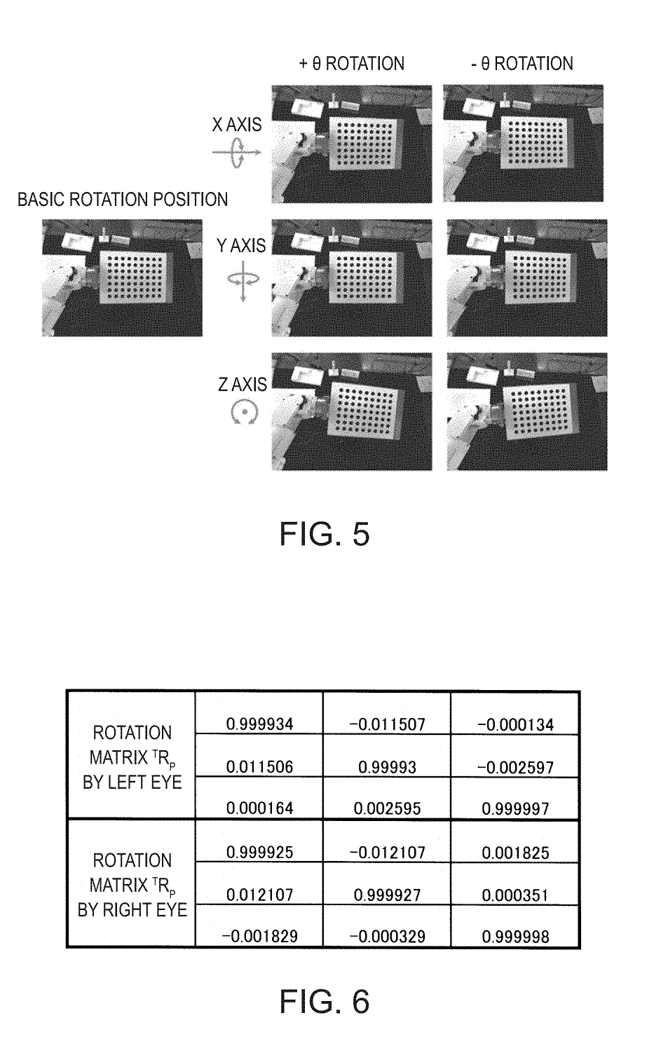

FIG. 5 is an explanatory diagram illustrating an example of pattern images at a plurality of rotation positions acquired in step S130. These pattern images are images captured at theses plurality of rotation positions by performing ±θx, ±θy, and ±θz rotation of the arm 160 around each XYZ axes of the hand coordinate system Σ_{T} independently in a state where the TCP which is the origin point of the hand coordinate system Σ_{T} is fixed spatially and stopping the arm 160. In other words, the plurality of rotation positions include a basic rotation position, two rotation positions rotated around X axis from the basic rotation position, two rotation positions rotated around Y axis from the basic rotation position, and two rotation positions rotated around Z axis from the basic rotation position. The rotation angles θx, θy, and θz from the basic rotation position are set at 5 degrees each, but any rotation angle other than 0 degrees can be applied. However, if the rotation angle θ is too small, it is difficult to distinguish the difference in the pattern image resulting from the rotation, and if the rotation angle θ is too large, it is difficult to distinguish the arrangement of the calibration pattern 400 from the pattern image. Taking these points into consideration, it is preferable to set the rotation angles θx, θy, and θz to be within a range, for example, 3 degrees or more and 30 degrees or less. The calibration pattern 400 is a pattern in which black dots are arranged in a 9×7 grid pattern. Other calibration patterns like the checkerboard pattern may be used as well. The coordinate origin point of the pattern coordinate system Σ_{P} is at a predetermined position on the calibration pattern 400.

In step S140, the transformation ^{P}H_{C} or ^{C}H_{P} between the pattern coordinate system Σ_{P} and the camera coordinate system Σ_{C} is estimated for each pattern image captured in step S130. The estimation can be executed using standard software (for example, Open CV function “FindExtrinsicCameraParams2”) for estimating the extrinsic parameter of the camera with the intrinsic parameter acquired in step S120.

Instep S150, a rotation matrix ^{C}R_{T} or ^{T}R_{C} between the camera coordinate system Σ_{C} and the hand coordinate system Σ_{T} can be estimated using the transformation ^{P}H_{C} or ^{C}H_{P} acquired in step S140. Hereinafter, first, rotation around the X axis will be described as an example.

Frist, a rotation matrix ^{P}R_{C} of the transformation ^{P}H_{C} acquired from the pattern image of the basic rotation position is simply written as R(θ₀). In addition, the rotation matrix ^{P}R_{C} of the transformation ^{P}H_{C} acquired from the pattern image in a state being rotated ±θx around X axis will be written as R(θ₀+θx) and R(θ₀−θx), respectively. At this time, the following expressions are established.

R (θ₀+θx)=R (θ₀)·R (θx) (12a)

R (θx)=R (θ₀)⁻¹·R (θ₀+θx) (12b)

Here, the rotation matrix R(θx) is a rotation matrix that rotates the coordinate system by +θx from the basic rotation position. As expressed in Expression (12b), the rotation matrix R(θx) can be calculated as a product of the inverse matrix R(θ₀)⁻¹ of the rotation matrix R(θ₀) at the basic rotation position and the rotation matrix R(θ₀+θx) at a position being rotated by +θx from the basic rotation position.

In general, any rotation around three axes of coordinate system is expressed in a rotation matrix or three Euler angles in many cases, instead, the rotation can be expressed with one rotation axis and a rotation angle around the rotation axis. When using the latter expression, the rotation matrix R(θx) can be transformed to a rotation vector Rod(θx) given by the following expressions.

$$\begin{matrix}Rod ( θ x ) = ( \begin{matrix}{n}_{x} \\ {n}_{y} \\ {n}_{z}\end{matrix} ) & ( 13 b ) \\ θ x = \sqrt{{n}_{x}^{2} + {n}_{y}^{2} + {n}_{z}^{2}} & ( 13 b )\end{matrix}$$

Here, nₓ, n_{y}, and n_{z} are three axis components indicating a direction of the rotation axis. In other words, “rotation vector Rod” is a vector having a rotation axis direction as a vector direction and a rotation angle as a vector length. The transformation from the rotation matrix R(θx) to the rotation vector Rod(θx) can be performed using, for example, OpenCV function, “Rodrigues2”.

As described above, the rotation matrix R(θx) is a matrix representing the fact that the coordinate system is rotated by +θx around the X axis of the hand coordinate system Σ_{T} from the basic rotation position. Accordingly, the vector direction of the rotation vector Rod(θx) equivalent to the rotation matrix R(θx) indicates the rotation axis direction, that is, the X axis direction of the hand coordinate system Σ_{T} seen in the camera coordinate system Σ_{C}.

Here, consider the rotation matrix ^{C}R_{T} from the camera coordinate system Σ_{C} to the hand coordinate system Σ_{T}. As described as the “rotation matrix R property 2” with respect to the general homogeneous transformation matrix indicated in the above described Expressions (1a) to (1d), the three column components Rₓ, R_{y}, and R_{z} of a random rotation matrix R refer to three basic vectors of the coordinate system seen from the original coordinate system. Accordingly, a normalized rotation vector Rod*(θx) acquired by normalizing the length of the above-described rotation vector Rod(θx) to 1 is the X component (leftmost column component) of the rotation matrix ^{C}R_{T} from the camera coordinate system Σ_{C} to the hand coordinate system Σ_{T}.

$$\begin{matrix}{Rod}^{*} ( θ x ) = ( \begin{matrix}{n}_{x} / θ x \\ {n}_{y} / θ x \\ {n}_{z} / θ x\end{matrix} ) & ( 14 b ) \\ θ x = \sqrt{{n}_{x}^{2} + {n}_{y}^{2} + {n}_{z}^{2}} & ( 14 b )\end{matrix}$$

By performing the same process for Y axis and Z axis, three column components Rod*(θx), Rod*(θy), and Rod*(θz) of the rotation matrix ^{C}R_{T} from the camera coordinate system Σ_{C} to the hand coordinate system Σ_{T} can be acquired.

^{C}R_{T}=(Rod*(θx) Rod*(θ_{y}) Rod*(θ_{y})) (15)

The inverse transformation ^{T}R_{C} of the rotation matrix ^{C}R_{T} is the same as the transposed matrix of the rotation matrix ^{C}R_{T}. Thereby, if the normalized rotation vectors Rod*(θx), Rod*(θy), and Rod*(θy) can be arranged as a row component instead of a column component, a rotation matrix ^{T}R_{C} from the hand coordinate system Σ_{T} to the camera coordinate system Σ_{C} can be acquired directly.

In this way, in step S150, three rotation vectors Rod(θx), Rod(θy) , and Rod(θy) having directions of each rotation axes as the vector direction and the rotation angle as the vector length are estimated from the pattern image captured at the plurality of rotation positions in the rotation around each of the rotation axes of the hand coordinate system Σ_{T}, which is the target coordinate system. By arranging these components of the normalized rotation vectors Rod*(θx), Rod*(θy), and Rod*(θy) acquired by normalizing the rotation vectors as a row component or a column component, it is possible to determine the rotation matrix ^{C}R_{T} or ^{T}R_{C} constituting a coordinate transformation matrix ^{C}H_{T} or ^{T}H_{C} between the hand coordinate system Σ_{T} and the camera coordinate system Σ_{C}.

There is a possibility that a detection error may be included in the process in step S150. In this case, in the example illustrated in FIG. 5, it is possible to estimate other rotation matrixes R(−θx), and R(2θx) in addition to the rotation matrix R(θx) by using three pattern images captured at three rotation positions of the basic rotation position, and two rotation positions rotated ±θx around X axis from the basic rotation position. By using these other the rotation matrixes R(−θx), and R(2θx), respectively, a rotation matrix ^{T}R_{P} may be acquired from the above-described procedure, and an average of a plurality of the rotation matrixes ^{T}R_{P} may be acquired. The process of acquiring an average of the plurality of rotation matrixes is executable by, for example, transforming each rotation matrix to a quaternion, and performing the inverse transformation to the rotation matrix after the average of a plurality of quaternions is acquired.

Further, there is a possibility that the rotation matrix ^{T}R_{P} acquired by the above-described process does not have orthonormality. In this case, it is preferable to orthogonalize each column of the rotation matrix ^{T}R_{P} using some kind of orthogonalization means (for example, Gram-Schmidt orthogonalization method). It is preferable to select an axis orthogonal to an image plane (Z axis in the example of FIG. 5) as an axis serving as the base point for orthogonalization. As clear from FIG. 5, displacement on the image is the largest in a case of the rotation around the axis orthogonal to the image plane, and thereby the relative error is considered to be the smallest.

The rotation angles θx, θy, and θz on the X, Y, Z axes are already known. Therefore, in a case where the difference between the rotation angle detected in the above-described process and the known rotation angle exceeds the allowable range considering the detection error, it may be determined that the processing result is abnormal.

In step S160, the rotation matrix ^{T}R_{P} or ^{P}R_{T} between the hand coordinate system Σ_{T} and the pattern coordinate system Σ_{P} is calculated. In step S140 described above, in each pattern image, the transformation ^{P}H_{C} or ^{C}H_{P} between the pattern coordinate system Σ_{P} and the camera coordinate system Σ_{C} is estimated, and the rotation matrix ^{P}R_{C} or ^{C}R_{P} constituting the transformation ^{P}H_{C} or ^{C}H_{P} thereof is already known. For example, the rotation matrix ^{T}R_{P} between the hand coordinate system Σ_{T} and the pattern coordinate system Σ_{P} can be calculated with the following expression using the rotation matrix ^{C}R_{P} estimated in a specific rotation position (for example, basic rotation position) and the rotation matrix ^{T}R_{C} acquired in step S150.

^{T}R_{P}=^{T}R_{C}·^{C}R_{P} (16)

FIG. 6 is a table showing values of the rotation matrix ^{T}R_{P} acquired in step S160. In the present embodiment, since the transformation ^{T}H_{P} between the hand coordinate system Σ_{T} and the pattern coordinate system Σ_{P}, is unknown, there is no value for the rotation matrix ^{T}R_{P} as a correct answer. In FIG. 6, the estimated results independently using the right eye camera 170R and the left eye camera 170L of the robot 100 illustrated in FIG. 3 are shown. Since two of the rotation matrixes ^{T}R_{P} show good agreement, it can be understood that the rotation matrix ^{T}R_{P} is accurately estimated. Step S160 may be omitted.

In step S170, a translation vector ^{T}T_{P} or ^{P}T_{T} between the hand coordinate system Σ_{T} and the pattern coordinate system Σ_{P} is estimated. Here, first, consider the case where the calibration pattern 400 is rotated around X axis of the hand coordinate system Σ_{T}.

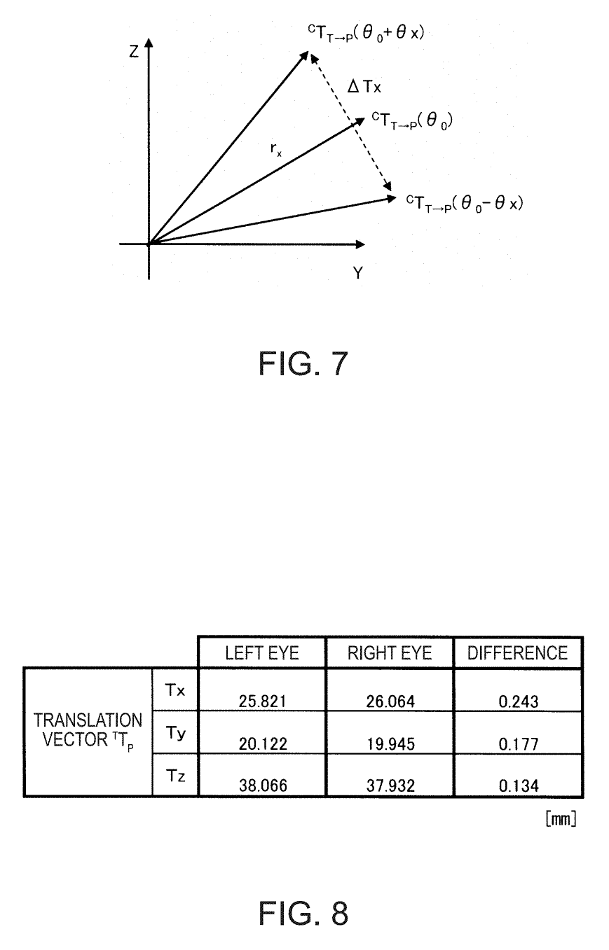

FIG. 7 is a graph that a translation vector ^{T}T_{P}(θ₀) at the basic rotation position and translation vectors ^{T}T_{P}(θ₀+θx) and ^{T}T_{P}(θ₀−θx) at the rotation position acquired by rotating the calibration pattern 400 around X axis of the hand coordinate system Σ_{T} are projected on a YZ plane of a camera coordinate system. Here, assuming the length of the translation vector ^{T}T_{P} as rₓ, XYZ components of the translation vector ^{T}T_{P} as (Tx, Ty, Tz), and the difference between two translation vectors ^{T}T_{P}(θ₀+θX) and ^{T}T_{P}(θ₀−θx) as ΔTₓ, the following expression is established.

$$\begin{matrix}{r}_{x} = \sqrt{{T}_{y}^{2} + {T}_{z}^{2}} & ( 17 a ) \\ \vert Δ {T}_{x} \vert = 2 {r}_{x} sin {θ}_{x} & ( 17 b ) \\ {r}_{x} = \frac{\vert Δ {T}_{x} \vert}{2 sin {θ}_{x}} & ( 17 c )\end{matrix}$$

Expressions similar to Expressions (17a) to (17c) are established around Y axis rotation and Z axis rotation, and are given as below.

$$\begin{matrix}{r}_{x}^{2} = {T}_{y}^{2} + {T}_{z}^{2} = {( \frac{\vert Δ {T}_{x} \vert}{2 sin {θ}_{x}} )}^{2} & ( 18 a ) \\ {r}_{y}^{2} = {T}_{z}^{2} + {T}_{x}^{2} = {( \frac{\vert Δ {T}_{y} \vert}{2 sin {θ}_{y}} )}^{2} & ( 18 b ) \\ {r}_{z}^{2} = {T}_{x}^{2} + {T}_{y}^{2} = {( \frac{\vert Δ {T}_{z} \vert}{2 sin {θ}_{z}} )}^{2} & ( 18 c )\end{matrix}$$

When Expressions (18a) to (18c) are deformed, the following expression can be acquired.

$$\begin{matrix}{T}_{x} = \sqrt{\frac{{r}_{y}^{2} + {r}_{z}^{2} - {r}_{x}^{2}}{2}} & ( 19 a ) \\ {T}_{y} = \sqrt{\frac{{r}_{z}^{2} + {r}_{x}^{2} - {r}_{y}^{2}}{2}} & ( 19 b ) \\ {T}_{z} = \sqrt{\frac{{r}_{x}^{2} + {r}_{y}^{2} - {r}_{z}^{2}}{2}} & ( 19 c )\end{matrix}$$

As explained in FIG. 5 described above, the calibration pattern 400 is rotated while fixing the TCP which is the coordinate origin point of the hand coordinate system Σ_{T}. Since the origin position of the pattern coordinate system Σ_{P} is set at the known point on the calibration pattern 400, the origin position of the pattern coordinate system Σ_{P} can be detected by analyzing the pattern image. Therefore, the difference between the origin position of the pattern coordinate system Σ_{P} from a first pattern image after +θx rotation from the basic rotation position and the origin position of the pattern coordinate system Σ_{P} acquired from a second pattern image after −θx rotation is equal to the difference ΔTₓ between the translation vectors ^{T}T_{P}(θ₀+θx) and ^{T}T_{P}(θ₀−θx) illustrated in FIG. 7. This also applies to the rotation around the Y axis and the rotation around the Z axis. According to Expressions (18a) to (18c) and Expressions (19a) to (19c) described above, the translation vector ^{T}T_{P} from the hand coordinate system Σ_{T} to the pattern coordinate system Σ_{P} can be estimated.

In step S160 described above, the rotation matrix ^{T}R_{P} or ^{P}R_{T} between the hand coordinate system Σ_{T} and the pattern coordinate system Σ_{P} is acquired. If the translation vector ^{T}T_{P} from the hand coordinate system Σ_{T} to the pattern coordinate system Σ_{P} can be estimated by a process in step S170 described above, the translation vector ^{P}T_{T} from the pattern coordinate system Σ_{P} to the hand coordinate system Σ_{T} can be calculated with Expression (2) described above.

In this way, in step S170, square sums rₓ², r_{y}², and r_{z}² of two translation vector components of two coordinate axis directions orthogonal to each rotation axis can be estimated among three components Tₓ, T_{y}, T_{z} of the translation vector ^{P}T_{T} or ^{T}T_{P} constituting a transformation matrix ^{P}H_{T} or ^{T}H_{P} between the pattern coordinate system Σ_{P} and the hand coordinate system Σ_{T} from the pattern image captured at the plurality of rotation positions rotating around each rotation axis of the hand coordinate system Σ_{T}, which is the target coordinate system. In addition, the translation vector ^{P}T_{T} or ^{T}T_{P} constituting the transformation matrix ^{P}H_{T} or ^{T}H_{P} can be calculated from square sums rₓ², r_{y}², and r_{z}² of the translation vector components estimated respectively in the three rotation axes.

FIG. 8 is a table showing values of the translation vector ^{T}T_{P} acquired in step S170. Here, similarly to FIG. 6, the estimated results using the right eye camera 170R and the left eye camera 170L independently are shown. Since two of the translation vectors ^{T}T_{P} show good agreement, it can be understood that the translation vector ^{T}T_{P} is accurately estimated.

In step S180, a translation vector ^{C}T_{T} or ^{T}T_{C} between the camera coordinate system Σ_{C} and the hand coordinate system Σ_{T} is calculated from a transformation matrix ^{C}H_{P} or ^{P}H_{C} estimated at a specific rotation position (for example, basic rotation position) in step S140 and the translation vector ^{P}T_{T} or ^{T}T_{P} acquired in step S170. For example, the translation vector ^{C}T_{T} from the camera coordinate system Σ_{C} to the hand coordinate system Σ_{T} can be calculated by the following expression.

$$\begin{matrix}( \begin{matrix}{}_{}^{C}{T}{}_{T}^{} \\ 1\end{matrix} ) = {}_{}^{C}{H}{}_{P}^{} \cdot ( \begin{matrix}{}_{}^{P}{T}{}_{T}^{} \\ 1\end{matrix} ) \\ = ( \begin{matrix}{}_{}^{C}{R}{}_{P}^{} & {}_{}^{C}{T}{}_{P}^{} \\ 0 & 1\end{matrix} ) ( \begin{matrix}{}_{}^{P}{T}{}_{T}^{} \\ 1\end{matrix} )\end{matrix} \qquad ( 20 )$$

Here, ^{C}H_{P} is a homogeneous transformation matrix estimated from the pattern image of the specific rotation position (for example, basic rotation position) in step S140, and ^{P}T_{T} is a translation vector acquired in step S170. A translation vector ^{T}T_{C} from the hand coordinate system Σ_{T} to the camera coordinate system Σ_{C} can also be calculated with the same expression.

By the process in FIG. 4, the rotation matrix ^{C}R_{T} or ^{T}R_{C} and the translation vector ^{C}T_{T} or ^{T}T_{C} of the homogeneous transformation matrix ^{C}H_{T} or ^{T}H_{C} expressing the coordinate transformation between the hand coordinate system Σ_{T} and the camera coordinate system Σ_{C} which is the target coordinate system can be estimated. The acquired homogeneous transformation matrix ^{C}H_{T} or ^{T}H_{C} is stored in the non-volatile memory 230 as the extrinsic parameter 233 of the camera 170. It is possible to perform various detection process or control using the camera 170 with the extrinsic parameter 233 and the intrinsic parameter 232 of the camera 170. As the extrinsic parameter 233 of the camera 170, various parameters for calculating the coordinate transformation between the target coordinate system Σ_{T} and the camera coordinate system Σ_{C} can be applied. For example, the homogeneous transformation matrix ⁰H_{C} or ^{C}H₀ representing the coordinate transformation between the robot coordinate system Σ₀ and the camera coordinate system Σ_{C} may be stored as the extrinsic parameter 233.

In the present embodiment, three rotation axes X, Y, and Z are set around the origin point of the hand coordinate system Σ_{T} which is the target coordinate system, and the arm 160 is operated to rotate the calibration pattern 400 around each rotation axis and to be stopped at a plurality of rotation positions. The pattern image of the calibration pattern 400 at the plurality of rotation positions of the rotation around each rotation axis is captured by the camera 170, and a coordinate transformation matrix ^{T}H_{C} or ^{C}H_{T} between a hand coordinate system Σ_{T} and a camera coordinate system Σ_{C} can be estimated using these pattern images. In the processing procedure, directions of the three rotation axes seen in the camera coordinate system Σ_{C} using the pattern image of the plurality of rotation positions around each rotation axis can be estimated. In addition, since the three rotation axes X, Y, and Z are linearly independent of each other, the coordinate transformation matrix ^{T}H_{C} or ^{C}H_{T} between the hand coordinate system Σ_{T} and the camera coordinate system Σ_{C} can be determined from the directions of these rotation axes. As a result, an extrinsic parameter for calculating a coordinate transformation between the hand coordinate system Σ_{T} and the camera coordinate system Σ_{C} can be acquired, and thereby it is possible to detect a position of a target using the camera 170.

In the above-described embodiment, X axis, Y axis, and Z axis are selected as a rotation axis around the origin point of the hand coordinate system Σ_{T}, but as long as the three rotation axes are linearly independent, any three rotation axes can be selected. In the case of using three rotation axes other than X axis, Y axis, and Z axis, it may be transformed to components of X axis, Y axis, and Z axis of the hand coordinate system Σ_{T} from components of each axis of the estimated result. However, if the direction (X, Y, Z axis) of the three basic vectors of the hand coordinate system Σ_{T} is selected as the rotation axis, there is an advantage that it is easier to perform the above-described process. The three rotation axes need not be set around the origin point of the hand coordinate system Σ_{T} that is the target coordinate system, but may be set to other positions. If three rotation axes are set around the origin point of the target coordinate system, since the correspondence relation between the three rotation axes and the target coordinate system is simple, there is an advantage that the coordinate transformation matrix between the target coordinate system and the camera coordinate system can be easily determined from directions of the rotation axes seen in the camera coordinate system.

In the above-described embodiment, the basic rotation position was rotated to both positive side and negative side, but it may be rotated only to either one side in the rotation around each rotation axis. If the basic rotation position is rotated to both positive side and negative side, it is easier to perform the above-described process. Also, it is preferable that the value of the rotation angle on the positive side is equal to the value thereof on the negative side.

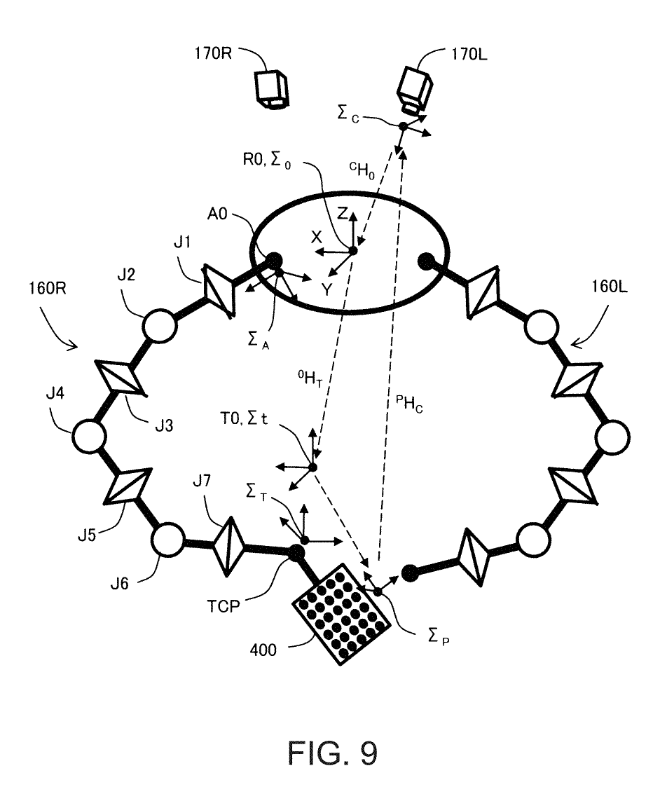

FIG. 9 is an explanatory diagram illustrating a robot coordinate system in the second embodiment. The difference from FIG. 3 of the first embodiment is that the calibration target coordinate system Σₜ is set at a position different from the hand coordinate system Σ_{T}, and the other configurations are the same as in the first embodiment. The target coordinate system Σₜ has, for example, a relative position and attitude fixed to the robot coordinate system Σ₀. In the calibration process of the camera 170 in the second embodiment, it is sufficient to replace “the hand coordinate system Σ_{T}” with “the target coordinate system Σₜ” and “TCP” with “coordinate origin point T0 of the target coordinate system Σₜ” in the process of FIG. 4 of the first embodiment, and the process procedure is the same as the first embodiment.

In this way, by setting the calibration target coordinate system Σₜ at a position different from the hand coordinate system Σ_{T}, it is possible to improve the detection accuracy of an object by the camera 170 in the vicinity of the target coordinate system Σₜ. For example, there are cases where the physically large hand 180 does not fit into a small working space. On the other hand, the target coordinate system Σₜ illustrated in FIG. 9 can be set in a narrow gap or inside of another object. Accordingly, if the calibration target coordinate system Σₜ is set at a position different from the hand coordinate system Σ_{T}, it is possible to improve the detection accuracy of an object by the camera 170 at any place.

The calibration process of the camera 170 is a process of determining an extrinsic parameter for calculating the coordinate transformation between the target coordinate system Σₜ having known relative position and attitude with respect to the robot coordinate system Σ₀ and the camera coordinate system Σ_{C}. A coordinate transformation matrix ^{C}Hₜ (or ^{t}H_{C}) between the target coordinate system Σₜ and the camera coordinate system Σ_{C} is represented by a product of a first transformation matrix ^{C}H_{P} (or ^{P}H_{C}) between the camera coordinate system Σ_{C} and the pattern coordinate system Σ_{P} and a second transformation matrix ^{P}Hₜ (or ^{t}H_{P}) between the pattern coordinate system Σ_{P} and the target coordinate system Σₜ. At this time, the process in step S140 in FIG. 4 corresponds to a process of estimating the first transformation matrix ^{C}H_{P} (or ^{P}H_{C}) from the pattern image captured at one specific rotation position (basic rotation position in the first embodiment) among a plurality of rotation positions rotated around three rotation axes around the origin point of the target coordinate system Σₜ. The process in step S150 corresponds to a process of estimating three rotation vectors having each rotation axis as a vector direction and rotation angle as a vector length from the pattern image captured at the plurality of rotation positions, normalizing each of these three rotation vectors, and determining a rotation matrix ^{C}Rₜ (or ^{t}R_{C}) constituting the coordinate transformation matrix ^{C}Hₜ (or ^{t}H_{C}) between the target coordinate system Σₜ and the camera coordinate system Σ_{C} by arranging the components of the normalized three rotation vectors as a row component or a column component. The process in step S170 corresponds to a process of estimating a square sum of two translation vector components in the two coordinate axis directions orthogonal to each rotation axis among three components of the translation vector constituting the second transformation matrix ^{P}Hₜ (or ^{t}H_{P}) from the pattern image captured at the plurality of rotation positions, and calculating a translation vector ^{P}Tₜ (or ^{t}T_{P}) constituting the second transformation matrix ^{P}Hₜ (or ^{t}H_{P}) from the square sum of the estimated translation vector component in the three rotation axes, respectively. The process in step S180 corresponds to a process of calculating the translation vector ^{C}Tₜ (or ^{t}T_{C}) of the coordinate transformation matrix ^{C}Hₜ (or ^{t}H_{C}) from the first transformation matrix ^{C}H_{P} (or ^{P}H_{C}) estimated at a specific rotation position and the translation vector ^{P}Tₜ (or ^{t}T_{P}) of the second transformation matrix ^{P}Hₜ (or ^{t}H_{P}). By executing these processes, it is possible to easily acquire the rotation matrix and the translation vector constituting the coordinate transformation matrix ^{C}Hₜ (or ^{t}H_{C}) between the target coordinate system Σₜ and the camera coordinate system Σ_{C} from the pattern image captured at the plurality of rotation positions of the rotation around each rotation axis.

In the above-described embodiment, the calibration related to the camera 170 of the head portion 150 of the robot 100 is explained. However, the invention can be applied to calibration of a camera contained in a robot installed in places other than the head portion 150 or a camera installed separately from the robot 100. The invention can be applied to not only a double arm robot but also to a single arm robot.

The invention is not limited to the above-described embodiments, examples, and modifications, and can be realized in various configurations without departing from the spirit thereof. For example, it is possible to replace or combine the technical features in the embodiments, examples, and modifications corresponding to the technical features in each embodiment described in the summary of the invention section as necessary in order to solve some or all of the above-mentioned problems or achieve some or all of the above effects. Unless the technical features are described as essential in the present specification, it can be deleted as appropriate.

The entire disclosure of Japanese Patent Application No. 2017-135108, filed Jul. 11, 2017 is expressly incorporated by reference herein.

What is claimed is:

1. A control device that controls a robot having an arm provided with a calibration pattern of a camera and the camera provided independently of the arm, comprising:
a processor that is configured to execute computer-executable instructions so as to control the robot,
wherein the processor is configured to:
move the arm to rotate a calibration pattern around three rotation axes linearly independent from each other and to stop at a plurality of rotation positions,
cause the camera to capture a pattern image of the calibration pattern at the plurality of rotation positions, and
determine parameters of the camera for calculating the coordinate transformation between a target coordinate system having a known relative position and attitude with respect to a robot coordinate system of the robot and a camera coordinate system of the camera using the pattern image captured at the plurality of rotation positions.

2. The control device according to claim 1,
wherein the three rotation axes are set around an origin point of the target coordinate system.

3. The control device according to claim 1,
wherein the processor
estimates three rotation vectors having a direction of each rotation axis as a vector direction and an angle of the rotation as a vector length from the pattern image captured at the plurality of rotation positions,
normalizes each of the three rotation vectors to acquire three normalized rotation vectors, and
determines a rotation matrix constituting a coordinate transformation matrix between the target coordinate system and the camera coordinate system by arranging the three normalized rotation vectors as a row component or a column component.

4. The control device according to claim 3,
wherein the coordinate transformation matrix between the target coordinate system and the camera coordinate system is represented by a product of a first transformation matrix between the camera coordinate system and a pattern coordinate system of the calibration pattern and a second transformation matrix between the pattern coordinate system and the target coordinate system, and
wherein the processor
(a) estimates the first transformation matrix from the pattern image captured at one specific rotation position among the plurality of the rotation positions,
(b) estimates a square sum of two translation vector components in two coordinate axis directions orthogonal to each rotation axis among three components of a translation vector constituting the second transformation matrix from the pattern image captured at the plurality of rotation positions, and calculates the translation vector constituting the second transformation matrix from the square sum of the translation vector components estimated respectively for the three rotation axes, and
(c) calculates a translation vector constituting the coordinate transformation matrix from the first transformation matrix estimated at the specific rotation position and the translation vector of the second transformation matrix.

5. The control device according to claim 1,
wherein the target coordinate system is a coordinate system having a relative position and attitude fixed with respect to the robot coordinate system of the robot independently of the arm.

6. The control device according to claim 1,
wherein the target coordinate system is a hand coordinate system of the arm.

7. A robot connected to the control device according to claim 1.

8. A robot connected to the control device according to claim 2.

9. A robot connected to the control device according to claim 3.

10. A robot connected to the control device according to claim 4.

11. A robot connected to the control device according to claim 5.

12. A robot connected to the control device according to claim 6.

13. A robot system comprising:
a robot; and
the control device connected to the robot according to claim 1.

14. A robot system comprising:
a robot; and
the control device connected to the robot according to claim 2.

15. A robot system comprising:
a robot; and
the control device connected to the robot according to claim 3.

16. A robot system comprising:
a robot; and
the control device connected to the robot according to claim 4.

17. A robot system comprising:
a robot; and
the control device connected to the robot according to claim 5.

18. A robot system comprising:
a robot; and
the control device connected to the robot according to claim 6.

19. A method for performing camera calibration in a robot system including a robot having an arm provided with a calibration pattern of a camera and the camera provided independently of the arm, the method comprising:
moving the arm to rotate a calibration pattern around three rotation axes linearly independent from each other and to stop at a plurality of rotation positions;
causing the camera to capture a pattern image of the calibration pattern at the plurality of rotation positions; and
determining parameters of the camera for calculating a coordinate transformation between a target coordinate system having a known relative position and attitude with respect to a robot coordinate system of the robot and a camera coordinate system of the camera using the pattern image captured at the plurality of rotation positions.
